(19) United States
(12) Patent Application Publication
(10) Pub. No.: US 2020/0254826 A1
(43) Pub. Date: Aug. 13, 2020

(54) TIRE

(71) Applicant: Sumitomo Rubber Industries, Ltd., Hyogo (JP)

(72) Inventor: Sawa OGIHARA, Kobe-shi (JP)

(73) Assignee: Sumitomo Rubber Industries, Ltd., Hyogo (JP)

(21) Appl. No.: 16/745,190

(22) Filed: Jan. 16, 2020

(30) Foreign Application Priority Data
Feb. 13, 2019 (JP) 2019-023720

(51) Int. Cl. B60C 13/00

(52) U.S. Cl. CPC B60C 13/001

(57) ABSTRACT

Provided is a tire that can prevent projections and recesses on an outer surface of a sidewall portion from becoming conspicuous while inhibiting occurrence of cracks.

The tire includes a sidewall portion 3. An outer surface of the sidewall portion 3 has a decorative pattern 5. The decorative pattern 5 includes a radially arranged ridge portion 6 in which a plurality of ridges 8 connected to each other at a center 7 extend radially.

### BACKGROUND OF THE INVENTION

### Field of the Invention

The present invention relates to a tire, and more specifically relates to a tire having a decorative pattern formed on an outer surface of a sidewall portion.

### Description of the Background Art

In general, a sidewall portion of a tire is covered with rubber having a small thickness. Therefore, projections and recesses called bulges and dents tend to appear locally on the outer surface of the sidewall portion, due to, for example, residual air or joint portions of a carcass that is an internal structure member of the tire.

In order to inhibit the projections and recesses from becoming conspicuous, Japanese Laid-Open Patent Publication No. 2014-205394 suggests a pneumatic tire in which a decorative pattern is formed on the outer surface of the sidewall portion. According to Japanese Laid-Open Patent Publication No. 2014-205394, the decorative pattern includes a plurality of unit patterns which are repeatedly arranged in the tire circumferential direction. The unit pattern is formed by projections.

When the unit pattern formed by projections is repeated in the tire circumferential direction like the decorative pattern disclosed in Japanese Laid-Open Patent Publication No. 2014-205394, a problem arises that stress concentrates on the bottom of a small groove formed between the projections, and crack originating from the bottom of the small groove is likely to occur.

The present invention is made in view of the aforementioned problem, and a main object of the present invention is to provide a tire that can prevent projections and recesses on an outer surface of a sidewall portion from becoming conspicuous while inhibiting occurrence of cracks.

### SUMMARY OF THE INVENTION

The present invention is directed to a tire that includes a sidewall portion. An outer surface of the sidewall portion has a decorative pattern. The decorative pattern includes a radially arranged ridge portion in which a plurality of ridges connected to each other at a center extend radially.

In the tire of the present invention, the decorative pattern preferably includes a plurality of the radially arranged ridge portions aligned in a tire circumferential direction.

In the tire of the present invention, the decorative pattern preferably includes a plurality of the radially arranged ridge portions aligned in a tire radial direction.

In the tire of the present invention, the decorative pattern preferably includes: two circumferential ridges that extend in a tire circumferential direction and are spaced from each other in a tire radial direction; and the radially arranged ridge portion disposed between the two circumferential ridges.

In the tire of the present invention, at least one of the ridges in the radially arranged ridge portion preferably intersects the circumferential ridge.

In the tire of the present invention, in the radially arranged ridge portion, preferably, the ridge is not disposed in a region between a first straight line that extends from the center at an angle of 75 to 85° relative to a tire radial direction, and a second straight line that extends from the center at an angle of 95 to 105° relative to the tire radial direction.

In the tire of the present invention, a plurality of radial pieces are preferably formed around the center and each disposed between the two ridges adjacent to each other. The radially arranged ridge portion preferably includes an equiangular-piece region in which the radial pieces having the same internal angle between the two ridges are aligned, and a non-equiangular-piece region in which the radial pieces having different internal angles are aligned.

In the tire of the present invention, the internal angle is preferably not greater than 20°.

In the tire of the present invention, the internal angle in the equiangular-piece region is preferably greater than the internal angle in the non-equiangular-piece region.

In the tire of the present invention, the non-equiangular-piece region is preferably formed such that the greater an angle of the ridge relative to a tire radial direction at the center is, the less the internal angle of the radial piece for the ridge is.

In the non-equiangular-piece region of the tire of the present invention, the internal angle is preferably 5 to 9°.

In the tire of the present invention, the outer surface of the sidewall portion has the decorative pattern. The decorative pattern includes the radially arranged ridge portion in which the plurality of ridges connected to each other at the center extend radially. In the radially arranged ridge portion, the ridges are densely arranged near the center, so that light is unlikely to be reflected between the ridges and the radially arranged ridge portion looks dark. Meanwhile, in the radially arranged ridge portion, the farther the ridge is from the center in the radial direction, the greater the distance between the ridges is, so that light is likely to be reflected between the ridges and the radially arranged ridge portion looks pale. Therefore, the decorative pattern allows difference between lightness and darkness to be highlighted in the radially arranged ridge portion on the outer surface of the sidewall portion, so that projections and recesses on the outer surface of the sidewall portion can be prevented from becoming conspicuous. Furthermore, in the radially arranged ridge portion, since a plurality of the ridges extend radially, stress that acts between the ridges can be dispersed, and, consequently, crack can be inhibited from occurring in the outer surface of the sidewall portion.

### BRIEF DESCRIPTION OF THE DRAWINGS

FIG. 1 is an enlarged view of a sidewall portion of a tire according to an embodiment;

FIG. 2 is an enlarged view of a decorative pattern shown in FIG. 1;

FIG. 3 is an enlarged cross-sectional view of a ridge shown in FIG. 2;

FIG. 4 is an enlarged view of a decorative pattern according to another embodiment of the present invention;

FIG. 5 is an enlarged view of a decorative pattern according to another embodiment of the present invention; and

FIG. 6 is an enlarged view of a sidewall portion of a tire of comparative example.

### DESCRIPTION OF THE PREFERRED EMBODIMENTS

An embodiment of the present invention will be described below with reference to the drawings.

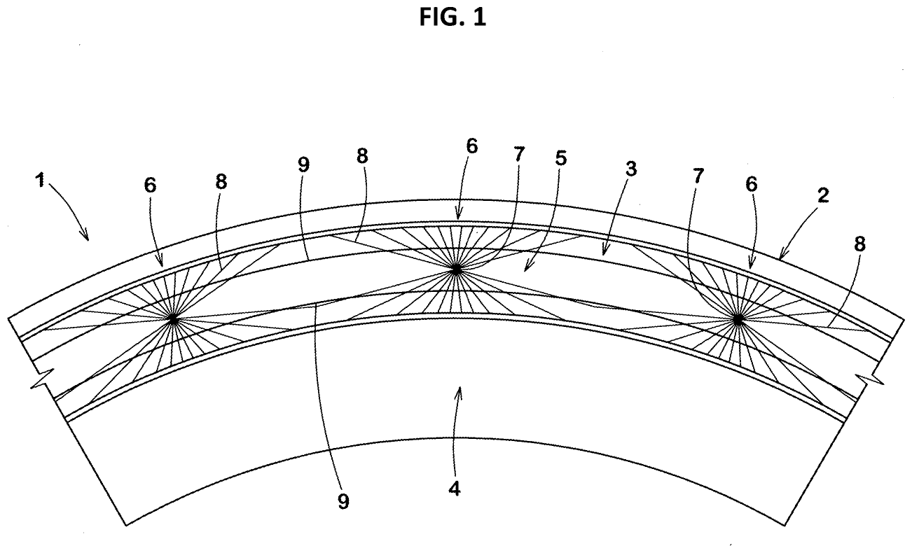

FIG. 1 is an enlarged view of a sidewall portion 3 of a tire 1 according to the present embodiment. In the present embodiment, the tire 1 has the sidewall portions 3 between a tread portion 2 and bead portions 4. In the present embodiment, the tire 1 for a passenger car is described as an example. However, the present invention is not limited thereto. The tire 1 may be, for example, a motorcycle tire or a heavy duty tire.

In the description herein, unless otherwise specified, dimensions of components of the tire 1, and the like are measured in a normal state. The normal state represents a state in which the tire 1 is mounted on a normal rim and is inflated with air to a normal internal pressure, and no load is applied to the tire 1.

The “normal rim” represents a rim that is defined by a standard, in a standard system including the standard with which the tire complies, for each tire, and is, for example, the “standard rim” in the JATMA standard, the “Design Rim” in the TRA standard, or the “Measuring Rim” in the ETRTO standard.

The “normal internal pressure” represents an air pressure that is defined by a standard, in a standard system including the standard with which the tire complies, for each tire, and is the “maximum air pressure” in the JATMA standard, the maximum value recited in the table “TIRE LOAD LIMITS AT VARIOUS COLD INFLATION PRESSURES” in the TRA standard, or the “INFLATION PRESSURE” in the ETRTO standard.

In the tire 1 of the present embodiment, an outer surface of the sidewall portion 3 has a decorative pattern 5. In the present embodiment, the decorative pattern 5 is formed, for example, over the entire circumference of the sidewall portion 3. However, the present invention is not limited thereto. The decorative pattern 5 may be formed in a strip-like shape so as to disconnect at both ends in the tire circumferential direction, and the decorative patterns 5 each formed in a strip-like shape may be disposed at intervals in the tire circumferential direction.

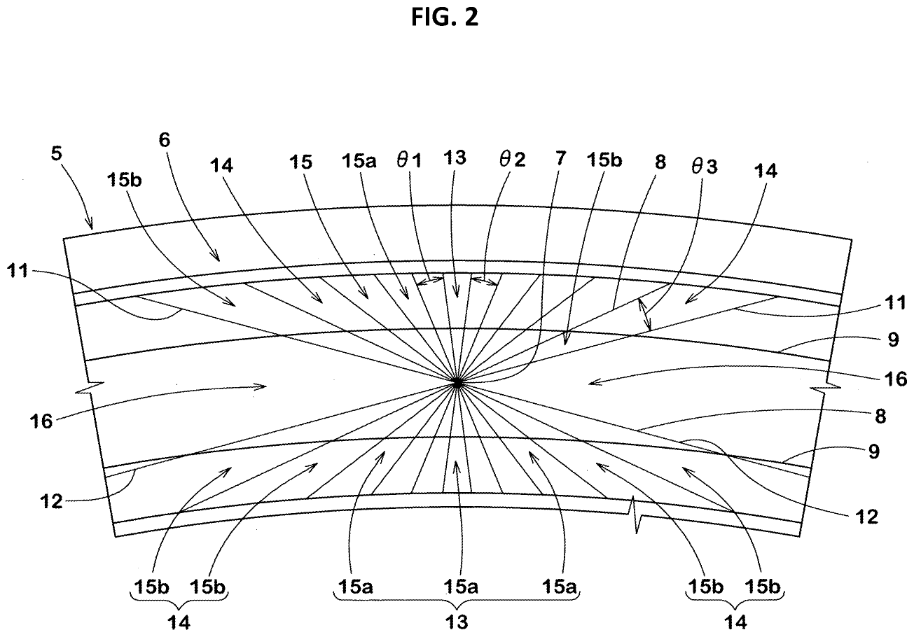

FIG. 2 is an enlarged view of the decorative pattern 5. As shown in FIG. 2, the decorative pattern 5 includes a radially arranged ridge portion 6 in which a plurality of ridges 8 radially extend and connect to each other at a center 7. In the present embodiment, the decorative pattern 5 includes a plurality of the radially arranged ridge portions 6 that are aligned in the tire circumferential direction.

In the radially arranged ridge portion 6, the ridges 8 are densely arranged near the center 7, so that light is unlikely to be reflected between the ridges 8 and the radially arranged ridge portion 6 looks dark. Meanwhile, in the radially arranged ridge portion 6, the farther the ridges 8 are from the center 7 in the radial direction, the greater the interval between the ridges 8 is, so that light is likely to be reflected between the ridges 8 and the radially arranged ridge portion 6 looks pale. Therefore, in the decorative pattern 5, the radially arranged ridge portion 6 allows difference between lightness and darkness to be highlighted on the outer surface of the sidewall portion 3, so that the projections and recesses on the outer surface of the sidewall portion 3 can be prevented from becoming conspicuous. Furthermore, in the radially arranged ridge portion 6, since a plurality of the ridges 8 radially extend, stress that acts between the ridges 8 can be dispersed, and, consequently, crack can be inhibited from occurring in the outer surface of the sidewall portion 3.

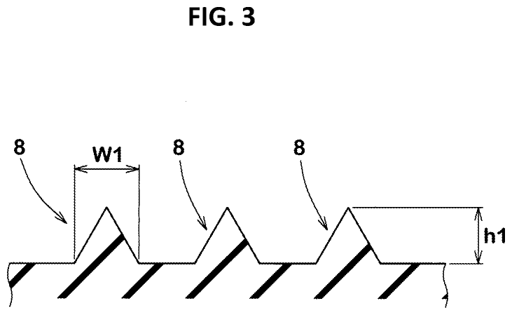

FIG. 3 is an enlarged cross-sectional view of the ridges 8 of the present embodiment. As shown in FIG. 3, in the present embodiment, each ridge 8 has, for example, a triangular cross-section. The ridge 8 extends in the length direction so as to have the same cross-sectional shape. However, the cross-section of the ridge is not limited thereto, and the ridge 8 may have, for example, a semi-circular, a trapezoidal, or a rectangular cross-sectional shape. Furthermore, the cross-sectional shape and area of the ridge 8 may change in the length direction of the ridge 8.

For example, a width W1 of the ridge 8 is preferably 0.4 to 2.0 mm. For example, a height h1 of the ridge 8 is preferably 0.1 to 1.0 mm.

As shown in FIG. 2, in the present embodiment, the decorative pattern 5 includes: two circumferential ridges 9 that are spaced from each other in the tire radial direction and extend in the tire circumferential direction; and the radially arranged ridge portion 6 disposed between the two circumferential ridges 9. In such a decorative pattern, the two circumferential ridges 9 appear to be non-parallel due to optical illusion, so that projections and recesses of the sidewall portion 3 can be made less conspicuous and excellent camouflaging performance is exhibited.

In order to enhance the above-described effect, at least one of the ridges 8 in the radially arranged ridge portion 6 intersects the circumferential ridge 9. More preferably, each of the ridges 8 in the radially arranged ridge portion 6 intersects the circumferential ridge 9.

In the radially arranged ridge portion 6, preferably, the ridge 8 is not disposed in a region 16 between an imaginary first straight line 11 that extends from the center 7 at an angle of 75 to 85° relative to the tire radial direction, and an imaginary second straight line 12 that extends from the center 7 at an angle of 95 to 105° relative to the tire radial direction. Hereinafter, the region 16 may be referred to as a blank region 16. For example, an angle between the first straight line 11 and the second straight line 12 is preferably 10 to 30°. In the radially arranged ridge portion 6 having such a structure, contrast of light between the blank region 16 and a region in which the ridges 8 are densely disposed is generated and excellent camouflaging effect is exhibited. In the present embodiment, the ridges 8 are disposed on the first straight line 11 and the second straight line 12.

A plurality of radial pieces 15 are formed around the center 7 and each disposed between the two ridges 8 adjacent to each other. For example, an internal angle θ1 between the two ridges 8 is not greater than 20° and is preferably 5 to 15°. Thus, crack is unlikely to occur in the outer surface of the sidewall portion 3, and durability of the sidewall portion 3 is improved.

The radially arranged ridge portion 6 preferably includes an equiangular-piece region 13 in which radial pieces 15a having the same internal angle θ1 between the two ridges 8 are arranged and a non-equiangular-piece region 14 in which radial pieces 15b having different internal angles are arranged. The radially arranged ridge portion 6 having such a structure is expected to enhance the optical illusion effect and thus exhibits excellent camouflaging performance.

In the present embodiment, the equiangular-piece region 13 having seven radial pieces 15a is disposed on each of the tire-radially inner side and outer side with respect to the center 7. The non-equiangular-piece region 14 includes two radial pieces 15b and is disposed on each of one side and the other side, in the tire circumferential direction, of each equiangular-piece region 13.

An internal angle θ2 in the equiangular-piece region 13 is preferably greater than an internal angle θ3 in the non-equiangular-piece region 14. For example, the internal angle θ2 in the equiangular-piece region 13 is preferably 5 to 20°. For example, the internal angle θ3 in the non-equiangular-piece region 14 is preferably 3 to 15° and more preferably 5 to 9°.

The non-equiangular-piece region 14 is preferably formed such that the greater an angle of the ridge 8 relative to the tire radial direction at the center 7 is, the less the internal angle θ3 of the radial piece 15 for the ridge 8 is. In other words, in the non-equiangular-piece region 14 of the present embodiment, the internal angle θ3 of the radial piece 15 is reduced from the equiangular-piece region 13 side toward the blank region 16 side. Thus, the optical illusion effect can be expected to be further enhanced, and the camouflaging performance is therefore improved.

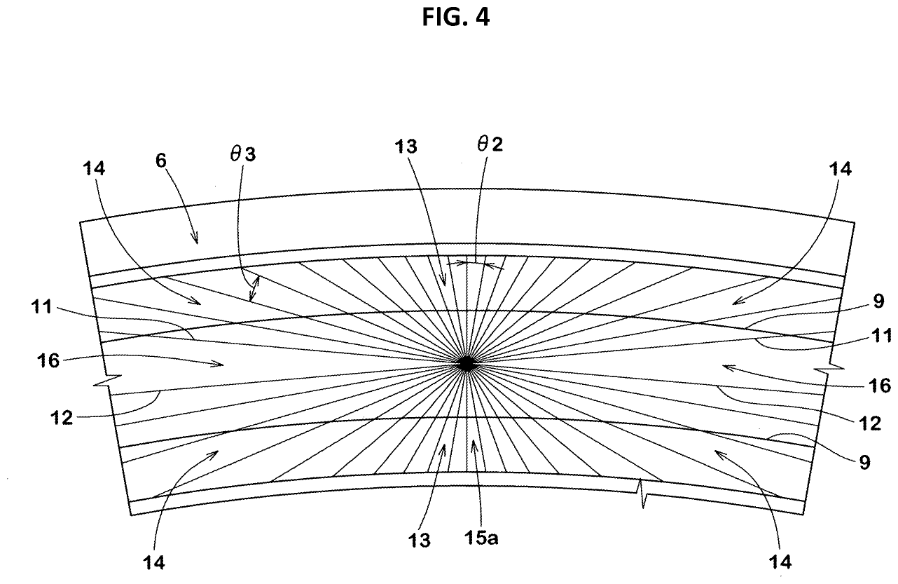

FIG. 4 is an enlarged view of the radially arranged ridge portion 6 according to another embodiment of the present invention. The components common to those in the above-described embodiment are denoted by the same reference numerals, and the description thereof is omitted. As shown in FIG. 4, in the present embodiment, the number of the ridges 8 is greater than that in the above-described embodiment, and the internal angle θ2 in the equiangular-piece region 13 is 8 to 12°.

In the present embodiment, the internal angle θ3 in the non-equiangular-piece region 14 is 5 to 9°. In the non-equiangular-piece region 14, the internal angle θ3 is decremented by 1° from the equiangular-piece region 13 toward the blank region 16. An angle between the first straight line 11 and the second straight line 12 is 5 to 15°. In the radially arranged ridge portion 6 having such a structure, contrast of light is further increased as compared with that in the embodiment shown in FIG. 2.

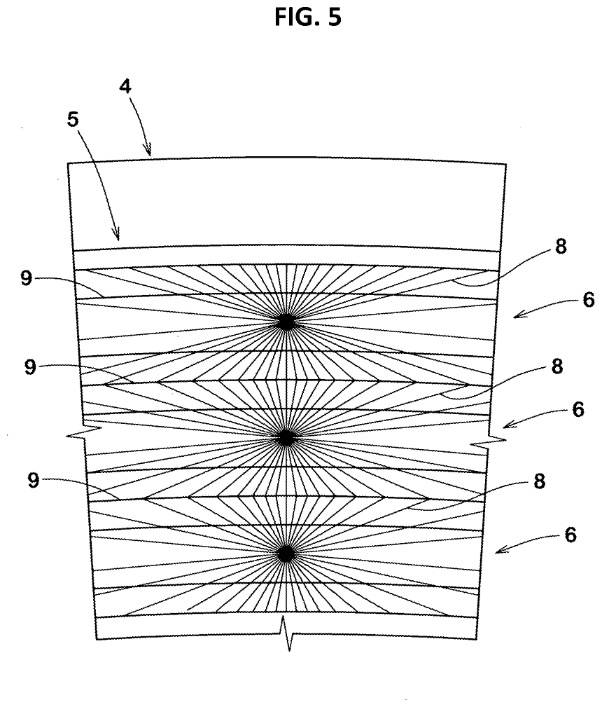

FIG. 5 shows the decorative pattern 5 according to another embodiment of the present invention. The decorative pattern 5 of the present embodiment includes a plurality of the radially arranged ridge portions 6 aligned in the tire radial direction. The decorative pattern 5 having such a structure can allow more excellent camouflaging performance to be exhibited.

In the present embodiment, the circumferential ridge 9 is disposed between the radially arranged ridge portions 6 aligned in the tire radial direction. The ridge 8 in the radially arranged ridge portion 6 on one side of the circumferential ridge 9 in the tire radial direction connects to the ridge 8 in the radially arranged ridge portion 6 on the other side of the circumferential ridge 9 in the tire radial direction, through the circumferential ridge 9. The ridges 8 that connect to each other through the circumferential ridge 9 are disposed so as to be bent at the circumferential ridge 9. By the ridges 8 being thus disposed, the optical illusion effect can be expected to be further enhanced.

Although the preferred embodiments of the present invention have been described above in detail, the present invention is not limited to the illustrated embodiments, and various modifications can be made to implement the present invention.

### EXAMPLES

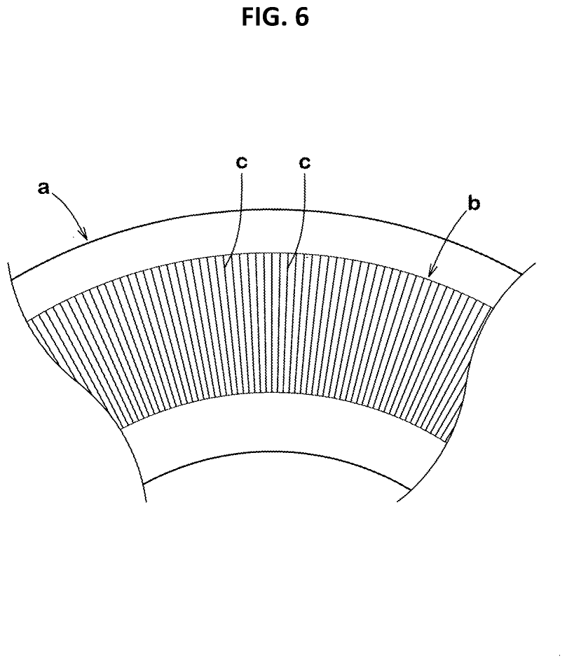

A tire which had the size of 205/55R16 and had, on the sidewall portion, a decorative pattern including the radially arranged ridge portion shown in FIG. 2 or FIG. 4 was produced. For comparative example, a tire that had, on a sidewall portion a, a decorative pattern b formed from a plurality of ridges c that extended in the tire radial direction was produced as a sample tire, as shown in FIG. 6. The tire of comparative example was substantially the same as the tires of examples except for the above-described structure. Each test tire was tested for the camouflaging performance and durability of the sidewall portion. Specifications common to the test tires and a test method are as follows.

Rim on which the tire was mounted: 16×6.5J

Tire internal pressure: 200 kPa

<Camouflaging Performance>

The outer surface of the sidewall portion was visually checked from various directions outdoors in fine weather, and the observer made sensory evaluation for a state where projections and recesses occurred in the sidewall portion. The results are indicated as scores with the result of comparative example being 100. The greater the value is, the more excellent camouflaging performance is.

<Durability of Sidewall Portion>

Running with the test tire under a constant vertical load was performed at a constant speed on a drum testing machine until damage to the sidewall portion occurred, and a running distance was measured when damage to the sidewall portion occurred. The results are indicated as indexes with the index of comparative example being 100. The greater the value of the index is, the more excellent durability of the sidewall portion is.

The test results are indicated in Table 1.

TABLE 1

| | Comparative | | |
|---|---|---|---|
| | example | Example 1 | Example 2 |
| Figure showing | FIG. 6 | FIG. 2 | FIG. 4 |
| decorative pattern | | | |
| Internal angle θ2 | — | 15 | 10 |
| in equiangular- | | | |
| piece region | | | |
| Internal angle θ3 | — | 10 to 15 | 5 to 9 |
| in non-equiangular- | | | |
| piece region | | | |
| Camouflaging | 100 | 110 | 115 |
| performance (score) | | | |
| Durability of | 100 | 117 | 115 |
| sidewall portion | | | |

According to the test results, it was confirmed that excellent camouflaging performance was exhibited and durability of the sidewall portions was also improved in the examples.

What is claimed is:

1. A tire comprising
a sidewall portion, wherein
an outer surface of the sidewall portion has a decorative pattern, and
the decorative pattern includes a radially arranged ridge portion in which a plurality of ridges connected to each other at a center extend radially.

2. The tire according to claim 1, wherein the decorative pattern includes a plurality of the radially arranged ridge portions aligned in a tire circumferential direction.

3. The tire according to claim 1, wherein the decorative pattern includes a plurality of the radially arranged ridge portions aligned in a tire radial direction.

4. The tire according to claim 1, wherein
the decorative pattern includes
two circumferential ridges that extend in a tire circumferential direction and are spaced from each other in a tire radial direction, and
the radially arranged ridge portion disposed between the two circumferential ridges.

5. The tire according to claim 4, wherein at least one of the ridges in the radially arranged ridge portion intersects the circumferential ridge.

6. The tire according to claim 1, wherein, in the radially arranged ridge portion, the ridge is not disposed in a region between a first straight line that extends from the center at an angle of 75 to 85° relative to a tire radial direction, and a second straight line that extends from the center at an angle of 95 to 105° relative to the tire radial direction.

7. The tire according to claim 1, wherein
a plurality of radial pieces are formed around the center and each disposed between the two ridges adjacent to each other, and
the radially arranged ridge portion includes an equiangular-piece region in which the radial pieces having the same internal angle between the two ridges are aligned, and a non-equiangular-piece region in which the radial pieces having different internal angles are aligned.

8. The tire according to claim 7, wherein the internal angle is not greater than 20°.

9. The tire according to claim 7, wherein the internal angle in the equiangular-piece region is greater than the internal angle in the non-equiangular-piece region.

10. The tire according to claim 7, wherein the non-equiangular-piece region is formed such that the greater an angle of the ridge relative to a tire radial direction at the center is, the less the internal angle of the radial piece for the ridge is.

11. The tire according to claim 7, wherein, in the non-equiangular-piece region, the internal angle is 5 to 9°.

12. The tire according to claim 2, wherein
the decorative pattern includes
two circumferential ridges that extend in a tire circumferential direction and are spaced from each other in a tire radial direction, and
the radially arranged ridge portion disposed between the two circumferential ridges.

13. The tire according to claim 12, wherein at least one of the ridges in the radially arranged ridge portion intersects the circumferential ridge.

14. The tire according to claim 3, wherein
the decorative pattern includes
two circumferential ridges that extend in a tire circumferential direction and are spaced from each other in a tire radial direction, and
the radially arranged ridge portion disposed between the two circumferential ridges.

15. The tire according to claim 14, wherein at least one of the ridges in the radially arranged ridge portion intersects the circumferential ridge.

16. The tire according to claim 2, wherein
a plurality of radial pieces are formed around the center and each disposed between the two ridges adjacent to each other, and
the radially arranged ridge portion includes an equiangular-piece region in which the radial pieces having the same internal angle between the two ridges are aligned, and a non-equiangular-piece region in which the radial pieces having different internal angles are aligned.

17. The tire according to claim 3, wherein
a plurality of radial pieces are formed around the center and each disposed between the two ridges adjacent to each other, and
the radially arranged ridge portion includes an equiangular-piece region in which the radial pieces having the same internal angle between the two ridges are aligned, and a non-equiangular-piece region in which the radial pieces having different internal angles are aligned.

18. The tire according to claim 4, wherein
a plurality of radial pieces are formed around the center and each disposed between the two ridges adjacent to each other, and
the radially arranged ridge portion includes an equiangular-piece region in which the radial pieces having the same internal angle between the two ridges are aligned, and a non-equiangular-piece region in which the radial pieces having different internal angles are aligned.

19. The tire according to claim 12, wherein
a plurality of radial pieces are formed around the center and each disposed between the two ridges adjacent to each other, and
the radially arranged ridge portion includes an equiangular-piece region in which the radial pieces having the same internal angle between the two ridges are aligned, and a non-equiangular-piece region in which the radial pieces having different internal angles are aligned.

20. The tire according to claim 14, wherein
a plurality of radial pieces are formed around the center and each disposed between the two ridges adjacent to each other, and
the radially arranged ridge portion includes an equiangular-piece region in which the radial pieces having the same internal angle between the two ridges are aligned, and a non-equiangular-piece region in which the radial pieces having different internal angles are aligned.
